(19) United States
(12) Patent Application Publication
(10) Pub. No.: US 2010/0214599 A1
(43) Pub. Date: Aug. 26, 2010

(54) Method for printing with XPSDrv printer driver

(75) Inventor: Xiaonong Zhan, Foster City, CA (US)

Correspondence Address: Chen Yoshimura LLP;Attention Ying Chen, 333 W. El Camino Real, Suite 380, Sunnyvale, CA, 94087, US

(73) Assignee: KONICA MINOLTA SYSTEMS LABORATORY, INC., Huntington Beach, CA (US)

(21) Appl. No.: 12/393,961

(22) Filed: Feb. 26, 2009

(51) Int. Cl. G06F 3/12

(52) U.S. Cl. 358/1.15

(57) ABSTRACT

A method used with the XPSDrv printer driver which reduces the overhead associated with loading the XPS filters is disclosed. The method may be implemented in a dynamic-link library (DLL) loaded by the configure module of the XPSDrv driver or a special function. The DLL or the special function dynamically modifies the XPSDrv driver's filter pipeline configuration file for each print job, so that only a subset of the filters, i.e., filters that are required for that print job, are included in the filter pipeline configuration file. In operation, the user uses the printer driver interface (UI) to set print property settings for the print job, and when the user exits the driver UI, the DLL or the special function modifies the filter pipeline configuration file based on the print property settings set by the user.

### BACKGROUND OF THE INVENTION

1. Field of the Invention

This invention relates to a method for processing data for printing, and in particular, it relates to a method for printing data using an XPS (XML Paper Specification) printer driver.

2. Description of Related Art

XPS (XML Paper Specification) is a Microsoft® document format. XPSDrv printer driver is a printer driver that uses XPS files as spool files. It is introduced in Windows Vista® and is now supported by many printers. According to documentation provided on Microsoft Developer's Network, “XPSDrv printer drivers are an enhanced version of the Version 3, GDI-based printer drivers that were used prior to Windows Vista. As with the GDI-based printer drivers, the XPSDrv printer drivers consist of a render module [and] a configuration module. The configuration module of an XPSDrv printer driver provides the same functions as the configuration module of the Printer Interface DLL of a GDI-based driver, but the XPSDrv configuration module also supports the Print Ticket and Print Capabilities technologies. The render module of an XPSDrv printer driver does not, necessarily, use the GDI-based rendering functions of a GDI-based printer driver. Instead, the render module of an XPSDrv printer driver consists of zero or more filters and a configuration file that describes the actions of each filter. The filters in the rendering module of an XPSDrv printer driver must also support the Print Ticket technology to correctly process the print job for the printer.” (See http://msdn.microsoft.com/en-us/library/aa506197.aspx.)

“The XPSDrv print driver is the component of the XPS print path that consumes an XPS spool file and emits page description language (PDL) data that a printer can consume. The configuration module contains the driver components that communicate printer features and settings to applications. XPSDrv printer drivers support the communications methods that Microsoft Win32-based applications and Windows Presentation Foundation (WPF)-based applications use. Both Win32-based applications and WPF applications can print to XPSDrv print drivers. Win32 applications use the GDI printing application programming interface (API), and the Microsoft-supplied conversion render module creates an XPS spool file for printing to the print filter pipeline. WPF applications use the WPF printing API to create an XPS spool file directly from the application.” (See http://msdn.microsoft.com/en-us/library/aa506189.aspx.)

“The render module of an XPSDrv printer driver contains the filters that render the contents of the XPS spool file for output to the printer. The set of rendering filters for a driver are instantiated and run in a filter pipeline. The Filter Pipeline Manager (FPM) manages the filters, and the Inter-Filter Communicator (IFC) controls the interaction between filters. . . . The Filter Pipeline Manager must: 1. Load and initialize filters. 2. Manage the data between filters. 3. Unload the filters when a print job is finished. Inter-Filter Communicators manage the transfer of data between filters, and the Filter Pipeline Manager manages Inter-Filter Communicators.” (See http://msdn.microsoft.com/en-us/library/aa907668.aspx.)

The filters are programs that prepare print data for the printer. The filters are provided by individual hardware vendors. Each filter typically performs a specific print processing function. Examples of filters include booklet, watermark, overlay, n-up, color conversion, page scaling, XPS rasterization filter, etc.

“The following process describes what happens to a set of filters in a pipeline: 1. The Filter Pipeline Manager reads the filter pipeline configuration (FPC) file. 2. The filters that the FPC specifies are loaded. 3. The filter pipeline is initialized, and the Filter Pipeline Manager starts the filter pipeline. 4. The first filter in the pipeline reads the XPS data through XPS or stream interfaces that the Filter Pipeline Manager offers, and then the filter processes the contents. 5. The first filter sends the processed XPS data to the second filter by using the interface that the Inter-Filter Communicator provides. 6. The Inter-Filter Communicator maintains the intermediate processing results until the second filter is ready. 7. Steps 1-6 are repeated from filter to filter until the results of the last filter are sent to the port that the driver has defined for output. If a printer uses XPS as a page description language (PDL), and no other processing is desired, you can use an empty (“pass through”) pipeline. If XPS is not the PDL for your printer, you will need to write a filter that converts XPS to the PDL of your printer, as well as any other processing that you want.” (See http://msdn.microsoft.com/en-us/library/aa907668.aspx.)

“The filter pipeline configuration file is an XML file that defines the following: Order of the filters in the pipeline. This order is defined by the ordering of the XML elements in the filter pipeline configuration file. Filter interfaces. These interfaces are defined by XML attributes in the filter pipeline configuration file. Input and output formats for each filter. These formats are defined by XML elements in the filter pipeline configuration file.” (See http://msdn.microsoft.com/en-us/library/aa506196.aspx.) The filter pipeline configuration file (also referred to as printer configuration file) is typically provided by individual hardware vender.

### SUMMARY

The present invention is directed to a method of printing XPS files that substantially obviates one or more of the problems due to limitations and disadvantages of the related art.

An object of the present invention is to enhance the performance of an XPS print driver.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method executed by a computer for printing data, which includes: storing a first plurality of filters in a memory, each filter being a program that processes print data; receiving a print job submission with associated print property settings; modifying a filter pipeline configuration file based on the print property settings, the filter pipeline configuration file specifying a second plurality of filters for performing data processing required by the print property settings, the second plurality of filters being a subset of the first plurality of filters; loading the second plurality of filters specified in the filter pipeline configuration file from the memory; and processing print data for the print job using the loaded filters to generate processed print data.

In another aspect, the present invention provides a computer program product that causes a computer to perform the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a filter pipeline manager and an XPS printer driver.

FIG. 2 is a flow chart illustrating a printing method according to an embodiment of the present invention.

### DETAILED DESCRIPTION OF PREFERRED EMBODIMENTS

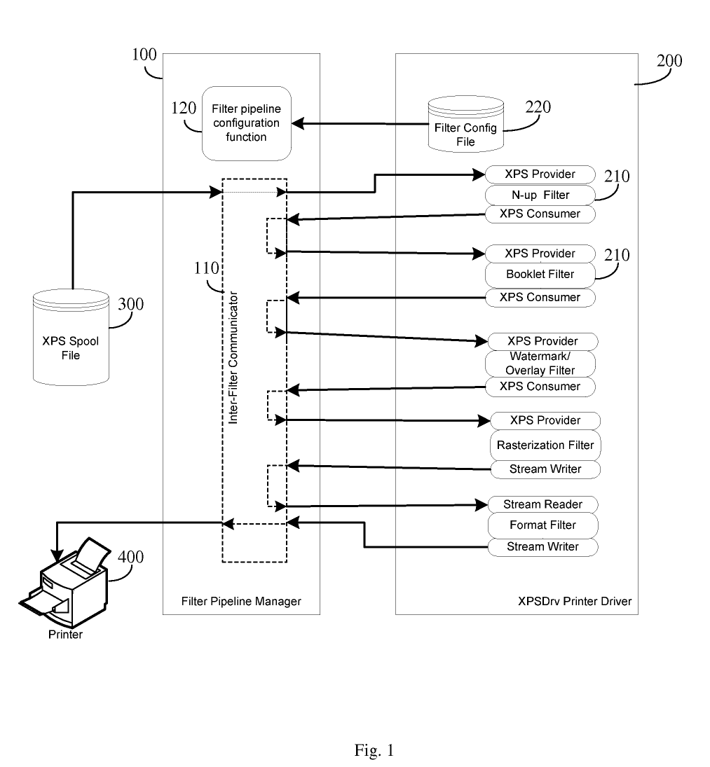

FIG. 1 schematically illustrates a filter pipeline manager 100 and an XPS printer driver 200, and the flow of processing an XPS spool file 300 and outputting the PDL data to a printer 400. In this disclosure, “XPS printer driver” refers to the XPSDrv printer driver provided by Microsoft. The filter pipeline manager 100 and an XPS printer driver 200 are computer programs stored in a memory of a computer and executed by a CPU of the computer. Embodiments of the present invention are implemented in this environment. The XPS printer driver 200 includes a plurality of filters 210 as well as a filter pipeline configuration file 220. The filter pipeline manager 100 includes an inter-filter communicator 110 and a filter pipeline configuration function 120. The filter pipeline configuration function 120 reads the filter pipeline configuration file 220 and processes it. The inter-filter communicator 110 manages the transfer of data between filters 210, and the filter pipeline manager 100 manages inter-filter communicator. The filter pipeline manager 100 also loads the filters 210 from the memory and initializes them, and unloads the filters when a print job is finished.

The filters 210 and the filter pipeline configuration file 220 are provided by the hardware vender, while the framework of the XPS printer driver 200 is provided by Microsoft. Conventionally, the filter pipeline configuration file specifies all filters available in the XPS printer driver 200. For each print job, the filter pipeline manager 100 loads all filters specified in the filter pipeline configuration file, even though not all filters will be required for a given print job. For example, if the print job does not involve N-up printing, then the N-up filter will not be required, but the N-up filter is nevertheless loaded. The filter pipeline manager 100 does not know which filters are required and which ones are not required until it opens the XPS spool file 300 and check the print ticket. In other words, according to conventional approaches, the filter pipeline manager 100 does not load filters according to the need for each print job in a dynamical fashion.

Loading all filters from a disk (or other storage devices) into RAM (random access memory) results in large overhead. For example, loading each XPS document filter costs approximately 10 seconds of delay, and loading each stream filter costs approximately 2 seconds of delay. XPS document filters are filters whose input and output data are both in the XPS format; stream filters are filters whose output data or both input and output data are stream data not in the XPS format. In the example shown in FIG. 1, the N-up, booklet, and watermark/overlay filters are stream filters, while the rasterization and format filters are stream filters. Thus, using conventional techniques, the more filters a printer driver provides, the larger the loading overhead becomes. Although in principle it is possible for a hardware vender to provide one filter that performs multiple functions to reduce loading overhead, such a practice would compromise the flexibility provided by the XPS framework, which is designed for each filter to perform a single function.

An embodiment of the present invention provides a method for reducing the overhead associated with loading the XPS filters. The method may be implemented in a dynamic-link library (DLL) provided by the printer hardware vender. The DLL is loaded by the configure module, and modifies the filter pipeline configuration file when the user exits (closes) the printer driver interface (UI). The method may also be implemented as a special function inside the configuration module (printer driver UI), and the driver UI may include a checkbox to allow the user to enable or disable this feature. According to this method, the DLL or the special function dynamically modifies the filter pipeline configuration file for each print job, so that only a subset of the filters, i.e., filters that are required for that print job, are included in the filter pipeline configuration file.

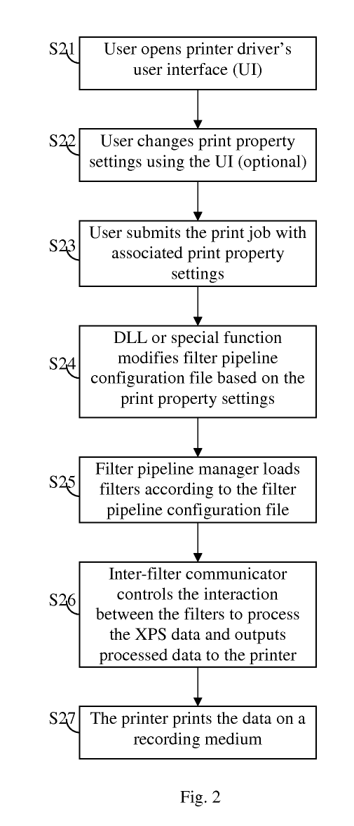

FIG. 2 illustrates this method in more detail. When a user requests to print a file, the application program displays a user interface (UI) for the printer driver (step S21). The user may use various tabs, buttons and other features of the UI to change the print property settings of the print job (step S22). For example, the user may set 2-on-1 printing (a form of N-up), watermark, etc. Step S22 is optional; i.e. the user may choose not to change any previously set print property settings. If the user does not change any print property settings, previously stored settings will be used for the current print job. The user then submits the print job with the associated print property settings by pressing an appropriate button such as the “print” button on the UI (step S23). Based on the print property settings, the DLL or the special function generates or modifies a filter pipeline configuration file, so that the file specifies only the filters required for the print job (step S24). The filters specified in the filter pipeline configuration file are typically a subset of all filters provided by the hardware vendor and stored in the memory; filters not required for the current print job are omitted from the filter pipeline configuration file.

Preferably, a filter pipeline configuration file is previously generated and stored in the computer, for example, from a previous print job. Thus, step S24 modifies an existing filter pipeline configuration file. If a filter pipeline configuration file has been previously stored based on previously stored print property settings, and if the user did not change any print property settings in step S22, then the previously stored filter pipeline configuration file may be used without modification. A list of all filters available within this driver may be stored in the printer driver program. For example, when the printer driver product is initially installed, the filter pipeline configuration file includes all filters available within the driver. This original filter pipeline configuration file may be backed up, and the file (which has a specific filename recognized by the filter pipeline manager, for example as defined in the printer driver inf file) is modified dynamically. Note that “modify” here broadly includes deleting an existing file and generating a new file with the same filename.

Then, the filter pipeline manager loads the filters from the memory according to the filter pipeline configuration file (step S25), and the inter-filter communicator (provided by Microsoft) controls the interaction between the filters to process the XPS data and outputs the processed data to the printer (step S26). The printer prints the data on a recording medium (step S27).

Tables I and II below are examples of filter pipeline configuration files. The second filter pipeline configuration file (table II) includes a subset of the filters in the first filter pipeline configuration file (table I). The second filter pipeline configuration file may be one that is dynamically generated and includes only the filters needed for a particular print job.

```
TABLE I
<Filters>
  <Filter dll  = “KOBZXX_D.dll”
      clsid  = “{D647D658-BBF6-415f-AFAC-070D64074C5D}”
      name  = “Form Create Filter”>
      <Input  guid = “{b8cf8530-5562-47c4-ab67-b1f69ecf961e}”
comment=“IID_IXpsDocumentProvider”/>
      <Output  guid = “{4368d8a2-4181-4a9f-b295-3d9a38bb9ba0}”
comment=“IID_IXpsDocumentConsumer”/>
        <Interleaving mode=“MarkupFirst” pieceSize=“0”/>
  </Filter>
  <Filter dll  = “KOBZXX_E.dll”
      clsid  = “{D647D658-BBF5-415f-AFAC-070D64074C5D}”
      name  = “Form Print Filter”>
      <Input  guid = “{b8cf8530-5562-47c4-ab67-b1f69ecf961e}”
comment=“IID_IXpsDocumentProvider”/>
      <Output  guid = “{4368d8a2-4181-4a9f-b295-3d9a38bb9ba0}”
comment=“IID_IXpsDocumentConsumer”/>
        <Interleaving mode=“MarkupFirst” pieceSize=“0”/>
  </Filter>
  <Filter dll  = “KOBZXX_B.dll”
      clsid  = “{D647D658-BBFF-415f-AFAC-070D64074C5D}”
      name  = “Watermark filter”>
      <Input  guid = “{b8cf8530-5562-47c4-ab67-b1f69ecf961e}”
comment=“IID_IXpsDocumentProvider”/>
      <Output  guid = “{4368d8a2-4181-4a9f-b295-3d9a38bb9ba0}”
comment=“IID_IXpsDocumentConsumer”/>
        <Interleaving mode=“MarkupFirst” pieceSize=“0”/>
  </Filter>
  <Filter dll  = “KOBZXX_A.dll”
      clsid  = “{D9B52406-92D3-4721-86E6-3CF78F6D5FC5}”
      name  = “Layout filter”>
      <Input  guid = “{b8cf8530-5562-47c4-ab67-b1f69ecf961e}”
comment=“IID_IXpsDocumentProvider”/>
      <Output  guid = “{4368d8a2-4181-4a9f-b295-3d9a38bb9ba0}”
comment=“IID_IXpsDocumentConsumer”/>
        <Interleaving mode=“MarkupFirst” pieceSize=“0”/>
  </Filter>
  <Filter dll  = “KOBZXX_C.dll”
      clsid  = “{D647D658-BBF8-415F-AFAC-070d64074C5D}”
    name  = “CleanUp filter”>
      <Input  guid = “{b8cf8530-5562-47c4-ab67-b1f69ecf961e}”
comment=“IID_IXpsDocumentProvider”/>
      <Output  guid = “{4368d8a2-4181-4a9f-b295-3d9a38bb9ba0}”
comment=“IID_IXpsDocumentConsumer”/>
        <Interleaving mode=“MarkupFirst” pieceSize=“0”/>
  </Filter>
  <Filter dll  = “KOBZXX_F.dll”
      clsid  = “{B787FF08-5A85-4baa-9542-13985CFC238F}”
      name  = “AddPT Filter”>
      <Input  guid = “{b8cf8530-5562-47c4-ab67-b1f69ecf961e}”
comment=“IID_IXpsDocumentProvider”/>
      <Output  guid = “{4368d8a2-4181-4a9f-b295-3d9a38bb9ba0}”
comment=“IID_IXpsDocumentConsumer”/>
        <Interleaving mode=“MarkupFirst” pieceSize=“0”/>
  </Filter>
  <Filter dll  = “rasterizer.dll”
      clsid  = “{1BE6AFB0-E950-4e9b-80BB-CFD5EDB979E7}”
      name  = “Rasterization Filter”>
      <Input  guid = “{4d47a67c-66cc-4430-850e-daf466fe5bc4}”
comment=“IID_IPrintReadStream” />
      <Output  guid = “{65bb7f1b-371e-4571-8ac7-912f510c1a38}”
comment=“IID_IPrintWriteStream” />
  </Filter>
</Filters>
```

```
TABLE II
<Filters>
  <Filter dll  = “KOBZXX_D.dll”
      clsid  = “{D647D658-BBF6-415f-AFAC-070D64074C5D}”
      name  = “Form Create Filter”>
      <Input  guid = “{b8cf8530-5562-47c4-ab67-b1f69ecf961e}”
comment=“IID_IXpsDocumentProvider”/>
      <Output  guid = “{4368d8a2-4181-4a9f-b295-3d9a38bb9ba0}”
comment=“IID_IXpsDocumentConsumer”/>
        <Interleaving mode=“MarkupFirst” pieceSize=“0”/>
  </Filter>
  <Filter dll  = “KOBZXX_E.dll”
      clsid  = “{D647D658-BBF5-415f-AFAC-070D64074C5D}”
      name  = “Form Print Filter”>
      <Input  guid = “{b8cf8530-5562-47c4-ab67-b1f69ecf961e}”
comment=“IID_IXpsDocumentProvider”/>
      <Output  guid = “{4368d8a2-4181-4a9f-b295-3d9a38bb9ba0}”
comment=“IID_IXpsDocumentConsumer”/>
        <Interleaving mode=“MarkupFirst” pieceSize=“0”/>
  </Filter>
  <Filter dll = “KOBZXX_C.dll”
      clsid  = “{D647D658-BBF8-415F-AFAC-070d64074C5D}”
      name  = “CleanUp filter”>
      <Input  guid = “{b8cf8530-5562-47c4-ab67-b1f69ecf961e}”
comment=“IID_IXpsDocumentProvider”/>
      <Output  guid = “{4368d8a2-4181-4a9f-b295-3d9a38bb9ba0}”
comment=“IID_IXpsDocumentConsumer”/>
        <Interleaving mode=“MarkupFirst” pieceSize=“0”/>
  </Filter>
  <Filter dll  = “KOBZXX_F.dll”
      clsid  = “{B787FF08-5A85-4baa-9542-13985CFC238F}”
      name  = “AddPT Filter”>
      <Input  guid = “{b8cf8530-5562-47c4-ab67-b1f69ecf961e}”
comment=“IID_IXpsDocumentProvider”/>
      <Output  guid = “{4368d8a2-4181-4a9f-b295-3d9a38bb9ba0}”
comment=“IID_IXpsDocumentConsumer”/>
        <Interleaving mode=“MarkupFirst” pieceSize=“0”/>
  </Filter>
  <Filter dll  = “rasterizer.dll”
      clsid  = “{1BE6AFB0-E950-4e9b-80BB-CFD5EDB979E7}”
      name  = “Rasterization Filter”>
      <Input  guid = “{4d47a67c-66cc-4430-850e-daf466fe5bc4}”
comment=“IID_IPrintReadStream” />
      <Output  guid = “{65bb7f1b-371e-4571-8ac7-912f510c1a38}”
comment=“IID_IPrintWriteStream” />
  </Filter>
</Filters>
```

Although the printing method is described above in the context of an XPS printer driver provided by Microsoft, the method may be used in other contexts where a printer driver system dynamically loads processing components for processing print data according to print property settings.

It will be apparent to those skilled in the art that various modification and variations can be made in the file printing method of the present invention without departing from the spirit or scope of the invention. Thus, it is intended that the present invention cover modifications and variations that come within the scope of the appended claims and their equivalents.

What is claimed is:

1. A method executed by a computer for printing data, comprising:
storing a first plurality of filters in a memory, each filter being a program that processes print data;
receiving a print job submission with associated print property settings;
modifying a filter pipeline configuration file based on the print property settings, the filter pipeline configuration file specifying a second plurality of filters for performing data processing required by the print property settings, the second plurality of filters being a subset of the first plurality of filters;
loading the second plurality of filters specified in the filter pipeline configuration file from the memory; and
processing print data for the print job using the loaded filters to generate processed print data.

2. The method of claim 1, further comprising printing the processed data on a recording medium.

3. The method of claim 1, wherein the filter pipeline configuration file further specifies an order of the second plurality of filters in a pipeline, filter interfaces, and input and output formats for each filter.

4. The method of claim 1, further comprising, before the receiving step:
displaying a user interface; and
receiving one or more inputs from a user specifying one or more print property settings.

5. A computer program product comprising a computer usable medium having a computer readable program code embedded therein for controlling a computer, the computer readable program code including a first plurality of filters in a memory, each filter being a program that processes print data, the computer readable program code configured to cause the computer to execute a process for printing data, the process comprising:
receiving a print job submission with associated print property settings; and
modifying a filter pipeline configuration file based on the print property settings, the filter pipeline configuration file specifying a second plurality of filters for performing data processing required by the print property settings, the second plurality of filters being a subset of the first plurality of filters;

6. The computer program product of claim 5, wherein the process further comprises:
loading the second plurality of filters specified in the filter pipeline configuration file from the memory; and
processing print data for the print job using the loaded filters to generate processed print data.

7. The computer program product of claim 5, wherein the filter pipeline configuration file further specifies an order of the second plurality of filters in a pipeline, filter interfaces, and input and output formats for each filter.

8. The computer program product of claim 5, wherein the process further comprises, before the receiving step:
displaying a user interface for the printer driver; and
receiving one or more inputs from a user specifying one or more print property settings.
